(19) United States
(12) Patent Application Publication
(10) Pub. No.: US 2019/0265542 A1
(43) Pub. Date: Aug. 29, 2019

(54) LIQUID CRYSTAL DISPLAY DEVICE

(71) Applicant: Panasonic Liquid Crystal Display Co., Ltd., Himeji-shi (JP)

(72) Inventor: Shohei HIGASHIHARA, Hyogo (JP)

(21) Appl. No.: 15/908,127

(22) Filed: Feb. 28, 2018

(51) Int. Cl. G02F 1/1335; G09G 3/36; G02F 1/1362

(52) U.S. Cl. CPC G02F 1/133514; G02F 1/136286; G02F 1/133512; G09G 3/3648

(57) ABSTRACT

A liquid crystal display device is disclosed. The liquid crystal display device includes a first substrate and a second substrate disposed opposite the first substrate. The first substrate includes a plurality of gate lines, a plurality of data lines, and a plurality of pixel electrodes. The second substrate includes a first colored region transmitting light of a first color and a second colored region transmitting light of a second color. A first light-blocking layer for blocking light is disposed in a boundary area between the first colored region and the second colored region. The first-light blocking layer is disposed between the first substrate and the second substrate.

### FIELD

This disclosure relates to a liquid crystal display device.

### BACKGROUND

A liquid crystal display (LCD) device is an electronic display that is widely used as a display for electronic devices such as, but not limited to, computers, televisions, cellular phones, and the like. An LCD device generally includes a thin film transistor (TFT) substrate and a color filter (CF) substrate. A liquid crystal layer is disposed between the TFT substrate and the CF substrate.

### SUMMARY

This disclosure relates generally to an electronic display device. More specifically, the disclosure relates to an electronic display device such as, but not limited to, a liquid crystal display device.

In an embodiment, an electronic display device is a liquid crystal display device.

In an embodiment, the liquid crystal display device is an in-plane switching (IPS) mode liquid crystal display device.

In an embodiment, the electronic display device can be included as a display for an electronic device such as, but not limited to, a display for a laptop computer

A liquid crystal display device is disclosed. The liquid crystal display device includes a first substrate and a second substrate disposed opposite the first substrate. The first substrate includes a plurality of gate lines, a plurality of data lines, and a plurality of pixel electrodes. The second substrate includes a first colored region transmitting light of a first color and a second colored region transmitting light of a second color. A first light-blocking layer for blocking light is disposed in a boundary area between the first colored region and the second colored region. The first-light blocking layer is disposed between the first substrate and the second substrate.

A liquid crystal display device is disclosed. The liquid crystal display device includes a first substrate and a second substrate disposed opposite the first substrate. The first substrate includes a plurality of gate lines, a plurality of data lines, and a plurality of pixel electrodes. The second substrate includes a first colored region transmitting light of a first color and a second colored region transmitting light of a second color. A first light-blocking layer is disposed in a boundary area between the first colored region and the second colored region. The first-light blocking layer is disposed between the first substrate and the second substrate. The second substrate further includes a second light-blocking layer disposed in the boundary area between the first colored region and the second colored region. The first colored region and the second colored region are disposed between the first light-blocking layer and second light-blocking layer. The second light-blocking layer extends in a direction parallel to the plurality of data lines.

### BRIEF DESCRIPTION OF THE DRAWINGS

References are made to the accompanying drawings that form a part of this disclosure, and which illustrate embodiments in which the systems and methods described in this specification can be practiced.

FIG. 1 illustrates a schematic diagram of a liquid crystal display device, according to an embodiment.

FIGS. 2A and 2B illustrate a color filter (CF) substrate, according to an embodiment.

FIGS. 3A and 3B illustrate a color filter (CF) substrate, according to an embodiment.

FIGS. 4A-4E illustrate a structure of a portion of a display panel, according to an embodiment.

FIG. 5A-5C illustrate a color filter (CF) substrate, according to an embodiment.

FIG. 6A and 6B illustrate a color filter (CF) substrate, according to another embodiment.

Like reference numbers represent like parts throughout.

### DETAILED DESCRIPTION

This disclosure relates generally to an electronic display device. More specifically, the disclosure relates to an electronic display device such as, but not limited to, a liquid crystal display device.

A liquid crystal display device generally includes a thin film transistor (TFT) substrate and a color filter (CF) substrate. A liquid crystal layer is disposed between the TFT substrate and the CF substrate. The CF substrate includes a plurality of colored regions (e.g., a red portion, a green portion, and a blue portion) and one or more light blocking layers (e.g., a black matrix). The one or more light blocking layers may be arranged in a boundary region between the plurality of colored regions. This arrangement can have a color mixing problem that occurs when light (e.g., from a backlight of the liquid crystal display device) leaks between adjacent pixel regions of the liquid crystal display device. The color mixing may be most evident when viewing the liquid crystal display device from an angle (e.g., an oblique angle).

Embodiments described in this specification may reduce an amount of color mixing with limited reduction of an aperture ratio of the pixels.

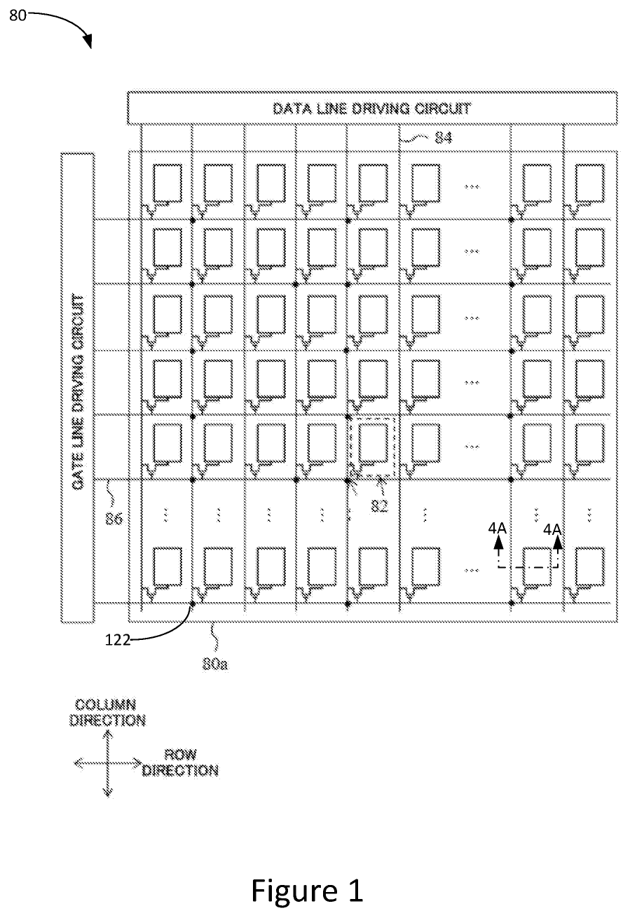

FIG. 1 illustrates a schematic diagram of a liquid crystal display device, according to an embodiment. The liquid crystal display device includes display panel 80 that displays an image, a driving circuit (data line driving circuit, gate line driving circuit) that drives display panel 80, a control circuit (not illustrated) that controls the driving circuit, and a backlight (not illustrated) that irradiates display panel 80 with light from a rear surface side.

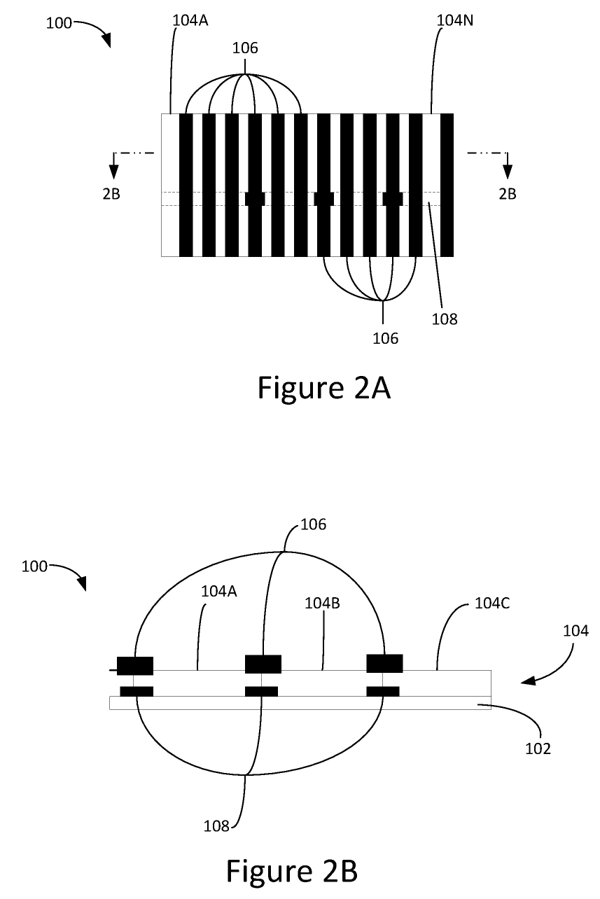

In display region 80a (e.g., the same as or similar to the display region 42 in FIGS. 2A and 2B) of display panel 80, pixels 82 (each of which is surrounded by two adjacent data lines 84 and two adjacent gate lines 86) are arrayed into a matrix shape in row and column directions. It is assumed that the column direction is a direction in which data line 84 extends, and that the row direction is a direction in which the gate line 86 extends.

FIGS. 2A and 2B illustrate a color filter (CF) substrate 100, according to an embodiment. FIG. 2A illustrates a plan view of the CF substrate 100. FIG. 2B illustrates an enlarged side sectional view of the CF substrate 100 when viewed along line 2B-2B. FIGS. 2A and 2B will generally be referenced collectively for simplicity of this specification.

The CF substrate 100 includes a glass substrate 102 and colored portions 104 that are formed on the glass substrate 102. The colored portions 104 include a plurality of colored regions 104A-104N. Each of the plurality of colored regions 104A-104N is configured to transmit light of a corresponding color. For example, in FIG. 2B, a first colored region 104A (e.g., a blue color region), a second colored region 104B (e.g., a green color region), and a third colored region 104C (e.g., a red colored region) are shown. The first colored region 104A can be configured to transmit light of a blue color. The second colored region 104B can be configured to transmit light of a green color. The third colored region 104C can be configured to transmit light of a red color.

It will be appreciated that the particular colors of the colored regions 104A-104N and the arrangement of the colored regions 104A-104N is an example and can vary according to principles described in this specification. FIG. 2B includes only a portion of the CF substrate 100. It will be appreciated that a full sectional view would include the plurality of colored regions 104A-104N.

A first light-blocking layer (e.g., a black matrix) 106 that is distinct from the CF substrate 100 is disposed in a boundary area between the first colored region 104A and the second colored region 104B. The first light-blocking layer 106 is also disposed in a boundary area between the second colored region 104B and the third colored region 104C. The colored portions 104 are disposed between the first light-blocking layer 106 and the glass substrate 102. The first light-blocking layer 106 can block oblique light being transmitted from the backlight (not shown) to reduce an amount of color mixing between the first colored region 104A and the second colored region 104B from light leakage. The first light-blocking layer 106 can also block oblique light being transmitted from the backlight (not shown) to reduce an amount of color mixing between the second colored region 104B and the third colored region 104C from light leakage. It will be appreciated that the first light-blocking layer 106 can block oblique light from being transmitted from the backlight to reduce color mixing between any two neighboring colored regions 104A-104N within the plurality of colored regions 104A-104N.

In an embodiment, a second-light blocking layer (e.g., a black matrix) 108 can be disposed in a boundary area between the first colored region 104A and the second colored region 104B. The second light-blocking layer 108 is also disposed in a boundary area between the second colored region 104B and the third colored region 104C. The second light-blocking layer 108 is disposed so that the plurality of colored regions 104A-104N are disposed between the first light-blocking layer 106 and the second light-blocking layer 108.

The second light-blocking layer 108 can block oblique light being transmitted from the backlight (not shown) to reduce an amount of color mixing between the first colored region 104A and the second colored region 104B from light leakage. The second light-blocking layer 108 can block oblique light being transmitted from the backlight (not shown) to reduce an amount of color mixing between the second colored region 104B and the third colored region 104C from light leakage.

It will be appreciated that the second light-blocking layer 108 can block oblique light from being transmitted from the backlight to reduce color mixing between any two neighboring colored regions 104A-104N within the plurality of colored regions 104A-104N.

The first light-blocking layer 106 extends in a direction parallel to the plurality of data lines (e.g., data lines 84 in FIG. 1).

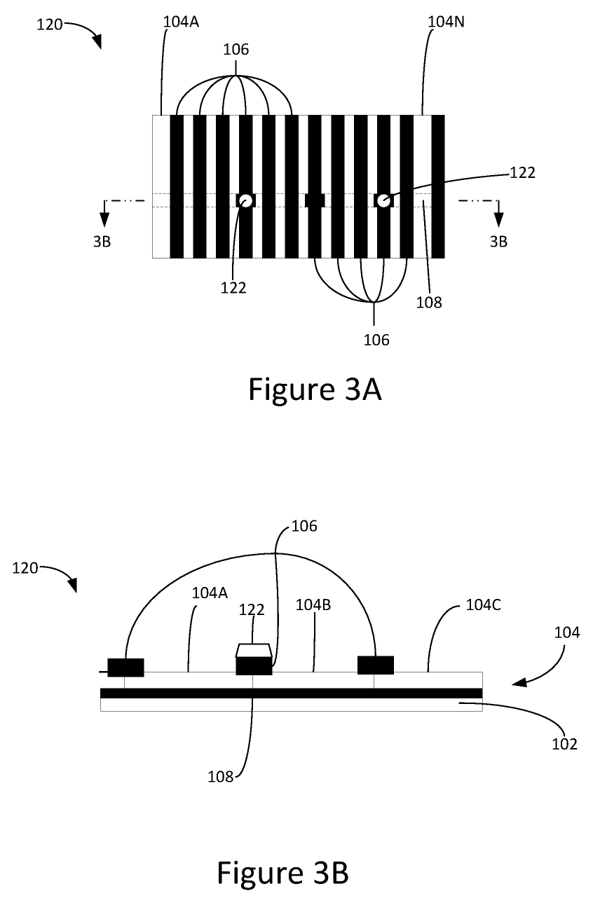

FIGS. 3A and 3B illustrate a CF substrate 120, according to an embodiment. FIG. 3A illustrates a plan view of the CF substrate 120. FIG. 3B illustrates an enlarged side sectional view of the CF substrate 120 when viewed along line 3B-3B. FIGS. 3A and 3B will generally be referenced collectively for simplicity of this specification.

The CF substrate 120 in FIGS. 3A and 3B can include features that are the same as or similar to the features in the CF substrate 100 of FIGS. 2A and 2B. For simplicity of this specification, features which have previously been described with respect to FIGS. 2A and 2B will not be described in additional detail.

In addition to the features of the CF substrate 100 (FIGS. 2A, 2B), the CF substrate 120 is provided with a plurality of spacers 122. In the illustrated embodiment, two spacers 122 are shown in FIG. 3A. It will be appreciated that the number of spacers 122 can vary. For example, there can be one spacer 122 per particular area of the second light-blocking layer 108. The spacers 122 are disposed to maintain a particular spacing (e.g., a gap) between a thin film transistor (TFT) substrate and the CF substrate 120. In an embodiment, there may be one or more columns of the first light-blocking layer 106 that is not provided with the spacer 122. In an embodiment, every column of the first light-blocking layer 106 can include the spacer 122.

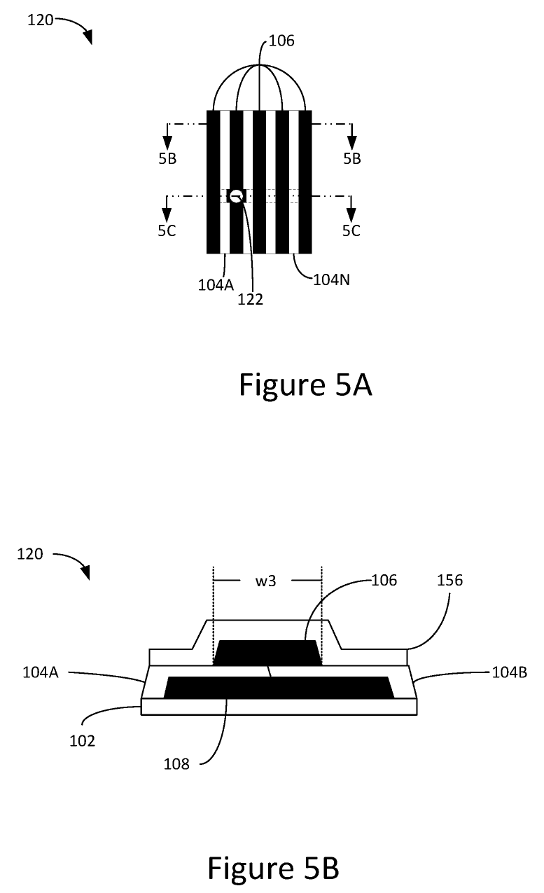

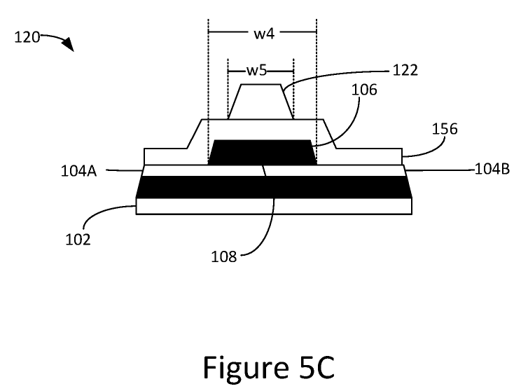

In the illustrated embodiment, the spacers 122 can be secured to the first light-blocking layer 106. A particular location associated with the spacers 122 is discussed in additional detail with respect to FIGS. 5A-5C below. The spacers 122 may be selected to be disposed in line with a gate line (e.g., gate lines 86 in FIG. 1).

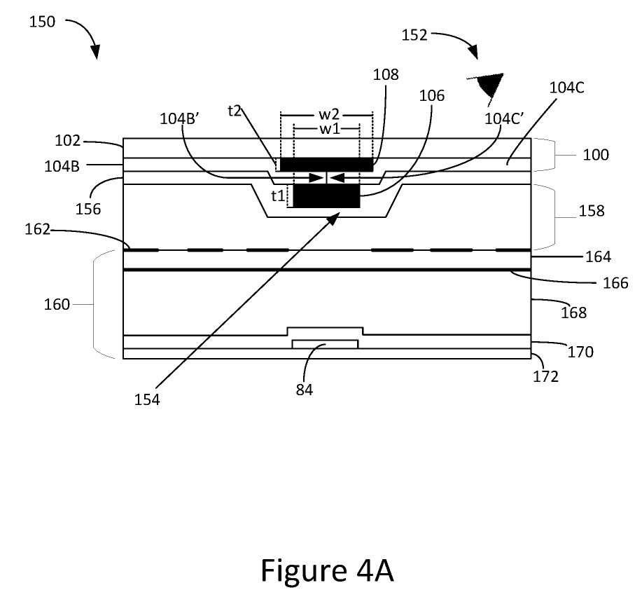

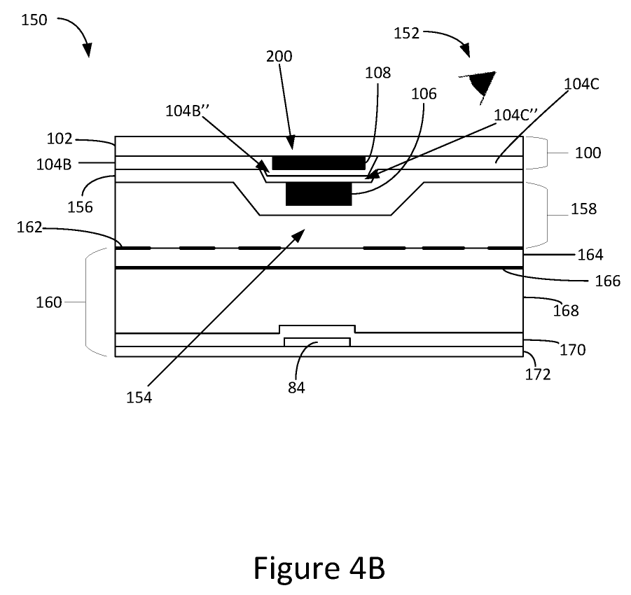

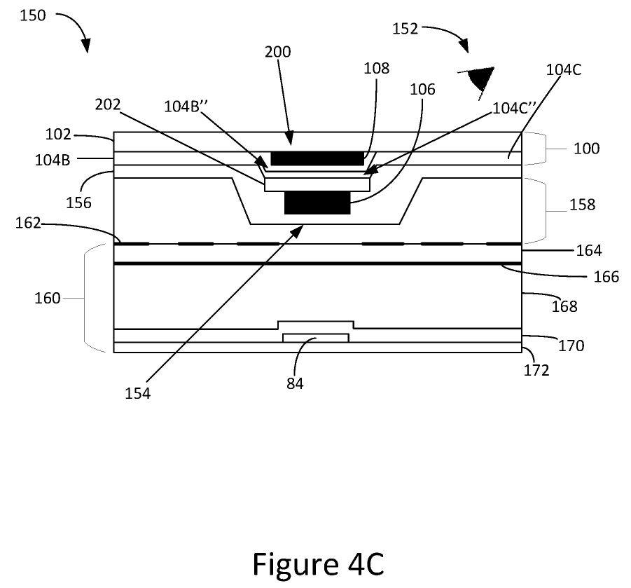

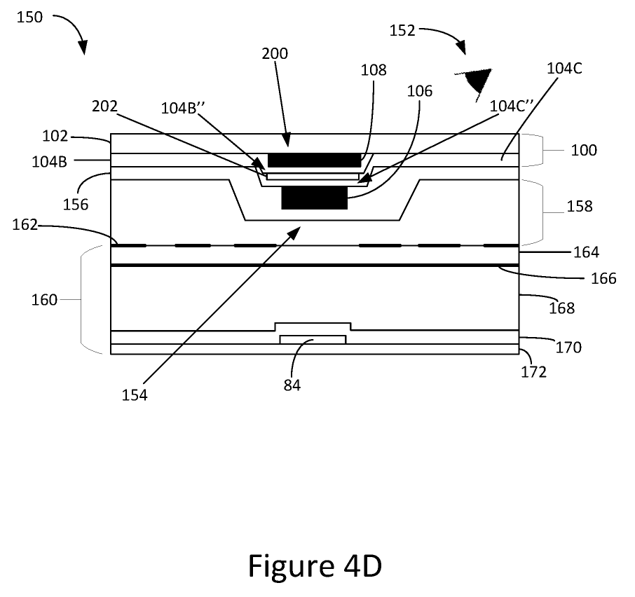

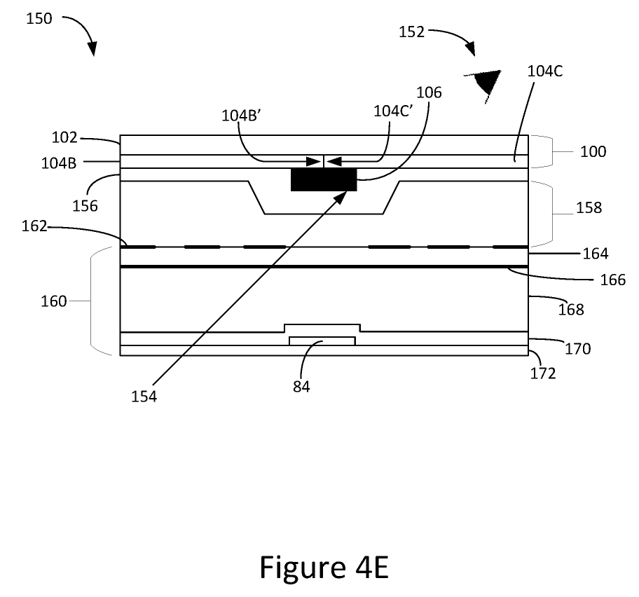

FIGS. 4A-4E illustrate a structure of a portion of a display panel 150, according to an embodiment. The display panel 150 can be the same as or similar to the display panel 80 as shown and described with respect to FIG. 1 above. In FIGS. 4A-4E, a user's oblique viewing angle is represented by an eye image 152. A light vector 154 from the backlight is illustrated. As can be seen in the illustration, the first light-blocking layer 106, colored regions 104B, 104C, and the second light-blocking layer 108 are arranged to reduce an amount of color mixing from the oblique light vector 154 that is observed by the user (as represented by the eye image 152).

FIG. 4A illustrates the display panel 150, according to an embodiment. In the embodiment of FIG. 4A, edges 104B′ and 104C′ of neighboring colored regions 104B, 104C of the colored region 104 abut.

In the illustrated embodiment, the CF substrate 100 includes the glass substrate 102 and the colored portion 104 having the colored regions 104B, 104C. An overcoat layer 156 is disposed between the CF substrate 100 and a liquid crystal layer 158. The overcoat layer 156 covers the first light-blocking layer 106 in a region between the first light-blocking layer 106 and the liquid crystal layer 158. The liquid crystal layer 158 is sandwiched between the CF substrate 100 and a thin film transistor (TFT) substrate 160.

The TFT substrate 160 includes pixel electrodes 162 formed on a first side of an upper layer insulating film 164 of the TFT substrate 160 that faces toward the liquid crystal layer 158. A common electrode 166 is formed on a second side of the upper layer insulating film 164 of the TFT substrate 160. The second side of the upper layer insulating film 164 is opposite the first side of the upper layer insulating film 164. An organic insulating film 168 and an insulating film 170 are formed over the data line 84 (FIG. 1). A glass substrate 172 is formed under the data line 84 (FIG. 1).

In the illustrated embodiment, the first light-blocking layer 106 and the second light-blocking layer 108 are both disposed in a region between the glass substrate 102 of the CF substrate 100 and the TFT substrate 160. The first light-blocking layer 106 is disposed relatively closer to the TFT substrate 160 than the first light-blocking layer 106. The colored regions 104B, 104C and the second light-blocking layer 108 are formed on the glass substrate 102 of the CF substrate 100.

The first light-blocking layer 106 has a width w1 and a thickness t1. In an embodiment, the width w1 may be relatively larger than the thickness t1. The second light-blocking layer 108 has a width w2 and a thickness t2. In an embodiment, the width w2 may be relatively larger than the thickness t2. The width w2 of the second light-blocking layer 108 may be relatively greater than the width w1 of the first light-blocking layer 106. In an embodiment, the thickness t2 of the second light-blocking layer 108 may be relatively smaller than the thickness t1 of the first light-blocking layer 106. In an embodiment, this selection of relative widths w1, w2 and thicknesses t1, t2 of the first light-blocking layer 106 and the second light-blocking layer 108 may be effective for obtaining a relatively high aperture ratio and while effectively blocking oblique light. In an embodiment, this can, for example, reduce an amount of color mixing between the neighboring colored regions 104B, 104C.

It will be appreciated that while neighboring portions 104B, 104C are described, the relationship is also true between other neighboring portions (e.g., 104A, 104B) of the plurality of colored regions 104A-104N.

FIG. 4B illustrates the display panel 150, according to an embodiment. In the embodiment of FIG. 4B, neighboring colored regions 104B, 104C of the CF substrate 100 overlap in a region 200 between the first light-blocking layer 106 and the second light-blocking layer 108.

In FIG. 4B, end portions 104B″, 104C″ of the colored regions 104B, 104C are overlapped with each other in the region 200 between the first light-blocking layer 106 and the second light-blocking layer 108. In an embodiment, the region 200 has a size that is relatively larger than the width of the first light-blocking layer 106. That is, as shown in FIG. 4B, an end of the colored region 104B is disposed on a side of the colored region 104C, and an end of the colored region 104C is disposed on a side of the colored region 104B.

In an embodiment, moving the first light-blocking layer 106 to be relatively closer to the TFT substrate 160 can increase an effectiveness of the first light-blocking layer 106 in blocking oblique light.

FIG. 4C illustrates the display panel 150, according to an embodiment. In the embodiment of FIG. 4C, neighboring colored regions of the CF substrate 100 overlap and another colored region is disposed on a TFT substrate side of the CF substrate 100.

Similar to the embodiment in FIG. 4B, in the embodiment of FIG. 4C, the neighboring colored regions overlap in the region 200 between the first light-blocking layer 106 and the second light-blocking layer 108. In the embodiment of FIG. 4C, another colored region 202 (e.g., colored region 104A) is included on the overlapping region 200 of the neighboring colored regions 104B, 104C. In an embodiment, the another colored region 202 can cause the first light-blocking layer 106 to be relatively closer to the TFT substrate 160, which can increase an effectiveness of the first light-blocking layer 106 in blocking oblique light.

It will be appreciated that in a display panel in which the colored regions 104A-104N include three colors (e.g., red, green, blue), the another colored region 202 will be whichever colored region is not selected from the neighboring colored regions 104B, 104C. For example, if the neighboring colored regions 104B, 104C are red and green, then the another colored region 202 will be blue. If the neighboring colored regions 104B, 104C are green and blue, the another colored region 202 will be red. If the neighboring colored regions 104B, 104C are blue and red, the another colored region 202 will be green. In an embodiment, the another colored region 202 could be the same as one of the neighboring colored regions 104B, 104C.

FIG. 4D illustrates the display panel 150, according to an embodiment. In the embodiment of FIG. 4D, the neighboring colored regions 104B, 104C of the CF substrate 100 overlap and another colored region is disposed between the ends of the colored regions 104B, 104C in the overlapping region.

Similar to the embodiment in FIG. 4C, in the embodiment of FIG. 4D, the neighboring colored regions overlap in the region 200 between the first light-blocking layer 106 and the second light-blocking layer 108. In the embodiment of FIG. 4D, another colored region 202 (e.g., colored region 104A) is included on the overlapping region 200 of the neighboring colored regions 104B, 104C. Different from the embodiment of FIG. 4C, in the embodiment in FIG. 4D the another colored region is disposed between ends of the colored regions 104B, 104C. In an embodiment, the another colored region 202 can cause the first light-blocking layer 106 to be relatively closer to the TFT substrate 160, which can increase an effectiveness of the first light-blocking layer 106 in blocking oblique light.

It will be appreciated that in a display panel in which the colored regions 104A-104N include three colors (e.g., red, green, blue), the another colored region 202 will be whichever colored region is not selected from the neighboring colored regions 104B, 104C. For example, if the neighboring colored regions 104B, 104C are red and green, then the another colored region 202 will be blue. If the neighboring colored regions 104B, 104C are green and blue, the another colored region 202 will be red. If the neighboring colored regions 104B, 104C are blue and red, the another colored region 202 will be green.

FIG. 4E illustrates the display panel 150, according to an embodiment. In the embodiment of FIG. 4E, the neighboring colored regions 104B, 104C of the CF substrate 100 abut each other.

In the embodiment of FIG. 4E, only the first light-blocking layer 106 is included. That is, the second light-blocking layer 108 is omitted from the embodiment in FIG. 4E. In the embodiment of FIG. 4E, the end 104B′ of the colored region 104B and the end 104C′ of the colored region 104C abut. In an embodiment, this may result in an improved blocking of oblique light due to being placed on a TFT substrate side of the CF substrate 100.

FIGS. 5A-5C illustrate the CF substrate 120 from FIGS. 3A and 3B, according to an embodiment. FIG. 5A illustrates a plan view of the CF substrate 120. FIGS. 5B and 5C illustrate side sectional views of the CF substrate 120 when viewed along line different lines.

FIG. 5A includes a single spacer 122. It will be appreciated that there may be more than one spacer 122. As shown in FIG. 5A, the spacer 122 is disposed on the first light-blocking layer 106 in a location of the gate line (e.g., gate line 86). The first light-blocking layer 106 is relatively widened at the location of the spacer 122 to accommodate the spacer 122. A difference in the width of the first light-blocking layer 106 at the location of the spacer 122 is shown with reference to FIGS. 5B and 5C.

FIG. 5B illustrates a sectional view of the CF substrate 120 when viewed along line 5B-5B. In the sectional view of FIG. 5B, the first light-blocking layer 106 has a width w3. No spacer 122 is visible in the sectional view since the line 5B-5B is in a location away from the spacer 122.

FIG. 5C illustrates a sectional view of the CF substrate 120 when viewed along line 5C-5C. In the sectional view of FIG. 5C, the first light-blocking layer 106 has a width w4. The width w4 is relatively greater than the width w3 (in FIG. 5B). The spacer 122 is also shown because of the location of the line 5C-5C. In the sectional view of FIG. 5C, a width w5 of the spacer 122 is relatively shorter than the width w4 of the first light-blocking layer 106.

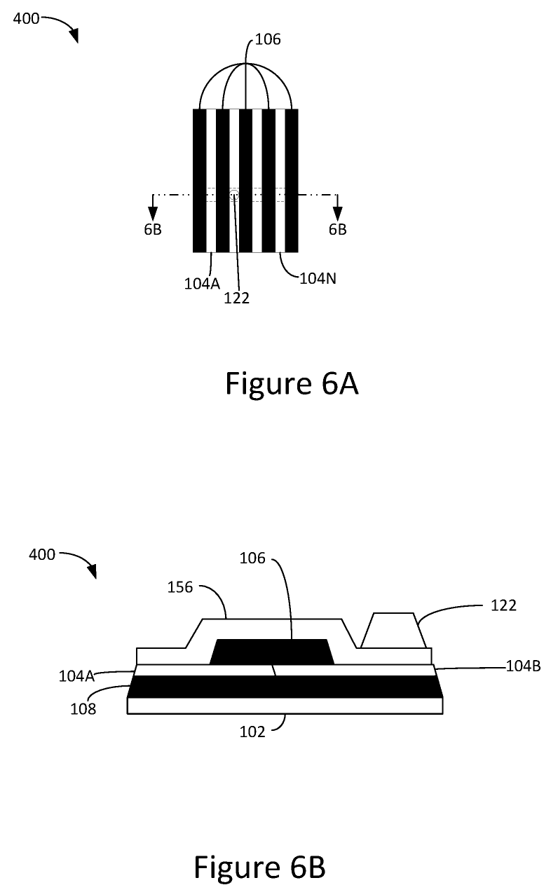

FIGS. 6A and 6B illustrate a CF substrate 400, according to an embodiment. FIG. 6A illustrates a plan view of the CF substrate 400. FIG. 6B illustrates an enlarged side sectional view of the CF substrate 400 when viewed along line 6B-6B. FIGS. 6A and 6B will generally be referenced collectively for simplicity of this specification.

The CF substrate 400 in FIGS. 6A and 6B is similar to the CF substrate 120 as shown and described in FIGS. 5A-5C. In the embodiment of FIGS. 6A and 6B, the spacer 122 is moved to a location that is between adjacent columns of the first light-blocking layer 106. As a result, a width of the first light-blocking layer 106 is not modified to accommodate the spacer 122. A single spacer 122 is shown, though it is to be appreciated that a plurality of spacers 122 can be provided on the CF substrate 400.

Aspects:

It is noted that any of aspects 1-16 below can be combined with any of aspects 17-19.

Aspect 1. A liquid crystal display device, comprising: a first substrate, including a plurality of gate lines, a plurality of data lines, and a plurality of pixel electrodes; a second substrate disposed opposite the first substrate, the second substrate including a first colored region transmitting light of a first color, a second colored region transmitting light of a second color; and a first light-blocking layer for blocking light disposed in a boundary area between the first colored region and the second colored region, wherein the first-light blocking layer is disposed between the first substrate and the second substrate.

Aspect 2. The liquid crystal display device according to aspect 1, wherein the second substrate further includes a second light-blocking layer disposed in the boundary area between the first colored region and the second colored region, and the first colored region and the second colored region are disposed between the first light-blocking layer and second light-blocking layer.

Aspect 3. The liquid crystal display device according to aspect 2, wherein the second light-blocking layer extends in a direction parallel to the plurality of data lines.

Aspect 4. The liquid crystal display device according to aspect 2, wherein the first-light blocking layer has a width and a thickness, the width being larger than the thickness, and the second-light blocking layer has a width and a thickness, the width being larger than the thickness, wherein the width of the first-light blocking layer is relatively smaller than the width of the second-light blocking layer.

Aspect 5. The liquid crystal display device according to aspect 4, wherein the thickness of the first-light blocking layer is relatively larger than the thickness of the second-light blocking layer.

Aspect 6. The liquid crystal display device according to aspect 2, further comprising a spacer that holds a clearance between the first substrate and the second substrate.

Aspect 7. The liquid crystal display device according to aspect 6, wherein the spacer is disposed on the plurality of gate lines, wherein the second light-blocking layer is wider than the spacer at a location of the spacer.

Aspect 8. The liquid crystal display device according to aspect 7, wherein the spacer is disposed between adjacent two of the plurality of data lines.

Aspect 9. The liquid crystal display device according to aspect 7, wherein the spacer is disposed on the plurality of data lines.

Aspect 10. The liquid crystal display device according to aspect 6, wherein the spacer is disposed between adjacent two of the plurality of data lines.

Aspect 11. The liquid crystal display device according to any one of aspects 1-10, wherein the first substrate is a thin film transistor and the second substrate is a color filter substrate.

Aspect 12. The liquid crystal display device according to any one of aspects 1-11, wherein the first colored region and the second colored region abut.

Aspect 13. The liquid crystal display device according to any one of aspects 1-12, wherein the first colored region and the second colored region overlap.

Aspect 14. The liquid crystal display device according to aspect 13, wherein the second substrate further includes a third colored region overlapped on the first colored region and the second colored region.

Aspect 15. The liquid crystal display device according to aspect 14, wherein the third colored region is overlapped on the first light-blocking layer.

Aspect 16. The liquid crystal display device according to aspect 15, wherein the first light-blocking layer is disposed between the third colored region and the first substrate.

Aspect 17. A liquid crystal display device, comprising: a first substrate, including a plurality of gate lines, a plurality of data lines, and a plurality of pixel electrodes; a second substrate disposed opposite the first substrate, the second substrate including a first colored region transmitting light of a first color, a second colored region transmitting light of a second color; and a first light-blocking layer disposed in a boundary area between the first colored region and the second colored region, wherein the first-light blocking layer is disposed between the first substrate and the second substrate, wherein the second substrate further includes a second light-blocking layer disposed in the boundary area between the first colored region and the second colored region, and the first colored region and the second colored region are disposed between the first light-blocking layer and second light-blocking layer, and wherein the second light-blocking layer extends in a direction parallel to the plurality of data lines.

Aspect 18. The liquid crystal display device according to aspect 17, further comprising a plurality of spacers, a first of the plurality of spacers is disposed on a first of the plurality of gate lines, wherein the first light-blocking layer is wider than the spacer at a location of the first of the plurality of spacers.

Aspect 19. The liquid crystal display device according to aspect 18, wherein the second light-blocking layer has a thickness at a location other than the first of the plurality of spacers that is relatively smaller than a thickness at the location of the first of the plurality of spacers.

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

1. A liquid crystal display device, comprising:
a first substrate, including a plurality of gate lines, a plurality of data lines, and a plurality of pixel electrodes;
a second substrate disposed opposite the first substrate, the second substrate including a first colored region transmitting light of a first color, a second colored region transmitting light of a second color; and
a first light-blocking layer for blocking light disposed in a boundary area between the first colored region and the second colored region, wherein the first-light blocking layer is disposed between the first substrate and the second substrate,
wherein the second substrate further includes a second light-blocking layer disposed in the boundary area between the first colored region and the second colored region,
the first colored region and the second colored region are disposed between the first light-blocking layer and second light-blocking layer, and
the first colored region and the second colored region are color filters.

2. (canceled)

3. The liquid crystal display device according to claim 1, wherein the second light-blocking layer extends in a direction parallel to the plurality of data lines.

4. The liquid crystal display device according to claim 1, wherein the first-light blocking layer has a width and a thickness, the width being larger than the thickness, and the second-light blocking layer has a width and a thickness, the width being larger than the thickness, wherein the width of the first-light blocking layer is relatively smaller than the width of the second-light blocking layer.

5. The liquid crystal display device according to claim 4, wherein the thickness of the first-light blocking layer is relatively larger than the thickness of the second-light blocking layer.

6. The liquid crystal display device according to claim 1, further comprising a spacer that holds a clearance between the first substrate and the second substrate.

7. The liquid crystal display device according to claim 6, wherein the spacer is disposed on the plurality of gate lines, wherein the second light-blocking layer is wider than the spacer at a location of the spacer.

8. The liquid crystal display device according to claim 7, wherein the spacer is disposed between adjacent two of the plurality of data lines.

9. The liquid crystal display device according to claim 7, wherein the spacer is disposed on the plurality of data lines.

10. The liquid crystal display device according to claim 6, wherein the spacer is disposed between adjacent two of the plurality of data lines.

11. The liquid crystal display device according to claim 1, wherein the first substrate is a thin film transistor and the second substrate is a color filter substrate.

12. The liquid crystal display device according to claim 1, wherein the first colored region and the second colored region abut.

13. The liquid crystal display device according to claim 1, wherein the first colored region and the second colored region overlap.

14. The liquid crystal display device according to claim 13, wherein the second substrate further includes a third colored region overlapped on the first colored region and the second colored region.

15. The liquid crystal display device according to claim 14, wherein the third colored region is overlapped on the first light-blocking layer.

16. The liquid crystal display device according to claim 15, wherein the first light-blocking layer is disposed between the third colored region and the first substrate.

17-19. (canceled)
